(19) United States
(12) Patent Application Publication
(10) Pub. No.: US 2018/0145620 A1
(43) Pub. Date: May 24, 2018

(54) SYSTEMS AND METHODS FOR PROVIDING GRID STABILITY

(71) Applicant: General Electric Company, Schenectady, NY (US)

(72) Inventors: Hua Zhang, Greer, SC (US); Wei Ning, Cincinnati, OH (US)

(21) Appl. No.: 15/357,899

(22) Filed: Nov. 21, 2016

(51) Int. Cl. H02P 9/08; H02P 9/04

(52) U.S. Cl. CPC H02P 9/08; H02P 9/04

(57) ABSTRACT

Exciter circuitry includes a controller that receives a first signal requesting that a generator coupled to the exciter circuitry stop providing real power to an electrical grid. The controller also sends a second signal to a turbine control system of a turbine coupled to the generator to close at least one fuel nozzle, at least one inlet guide vane, or at least one variable stator vane in response to receiving the first signal. The controller further instructs the exciter circuitry to provide direct current (DC) voltage and DC current to a rotor of the generator, wherein the DC voltage and the DC current causes the generator to operate synchronously with the electrical grid.

### BACKGROUND

This disclosure generally relates to maintaining synchronization of a generator with an electric grid when the generator is not in use. In particular, the subject matter relates to adjusting the operation of the generator when a turbine coupled to the generator is not using the generator to generate real power.

When a generator is not producing real power, a shaft of the generator may be stationary. After the generator receives a command to initialize and output power, a turbine shaft is rotated by a turning gear motor up to a relatively slow speed (e.g., 6 RPM). A starting motor (or generator-powered by a load commutated inverter) may take over and continue accelerating a rotating speed of the turbine shaft to about 10% to 30% of a synchronized speed. At this speed, turbine combustors may light off such that turbine blades start to generate mechanical torque force to accelerate to a speed at which the generator reaches synchronized frequency such that one or more breakers (e.g., switches) may be closed for the generator to connect to the electric grid. This process to bring the generator to synchronization speed may take an excessive amount of time, particularly during peak usage times. As the demand for power increases during peak usage times, the demand to place generators online more quickly also increases.

### BRIEF DESCRIPTION

Certain embodiments commensurate in scope with the present disclosure are summarized below. These embodiments are not intended to limit the scope of the present disclosure, rather these embodiments are intended only to provide a brief summary of possible forms of the present disclosure. Indeed, the present disclosure may encompass a variety of forms that may be similar to or different from the embodiments set forth below.

In one embodiment, a system includes a turbine that includes a turbine control system and at least one fuel nozzle, at least one inlet guide vane, or at least one variable stator vane. The system also includes a generator that couples to the turbine and provides power to an electrical grid. The system further includes an exciter that provides a direct current (DC) voltage and a DC current to a rotor of the generator. The exciter includes a controller that receives a first signal requesting that the generator stop providing real power to the electrical grid. The controller also sends a second signal to the turbine control system to close the at least one fuel nozzle, the at least one inlet guide vane, or the at least one variable stator vane in response to receiving the first signal. The controller further instructs the exciter to provide the DC voltage and the DC current to the rotor of the generator, wherein the DC voltage and the DC current cause the generator to operate synchronously with the electrical grid.

In another embodiment, a method includes receiving, via one or more processors, a first signal requesting that a generator stop providing real power to an electrical grid. The method also includes sending, via the one or more processors, a second signal to a turbine control system to close at least one fuel nozzle, at least one inlet guide vane, or at least one variable stator vane in response to receiving the first signal. The method further includes instructing, via the one or more processors, an exciter coupled to a rotor of the generator to provide direct current (DC) voltage and the DC current to the rotor of the generator, wherein the DC voltage and the DC current cause the generator to operate synchronously with the electrical grid.

In yet another embodiment, exciter circuitry includes a controller that receives a first signal requesting that a generator coupled to the exciter circuitry stop providing real power to an electrical grid. The controller also sends a second signal to a turbine control system of a turbine coupled to the generator to close at least one fuel nozzle, at least one inlet guide vane, or at least one variable stator vane in response to receiving the first signal. The controller further instructs the exciter circuitry to provide direct current (DC) voltage and DC current to a rotor of the generator, wherein the DC voltage and the DC current causes the generator to operate synchronously with the electrical grid.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of a turbine-generator system, in accordance with an embodiment of the present disclosure;

FIG. 2 is a block diagram of components that are part of the turbine-generator system of FIG. 1, in accordance with an embodiment of the present disclosure;

FIG. 3 is a flow diagram of a method for using the generator of FIGS. 1 and 2 to provide reactive power, in accordance with an embodiment of the present disclosure; and

FIG. 4 is a flow diagram of a method for using the generator of FIGS. 1 and 2 to provide real power, in accordance with an embodiment of the present disclosure.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

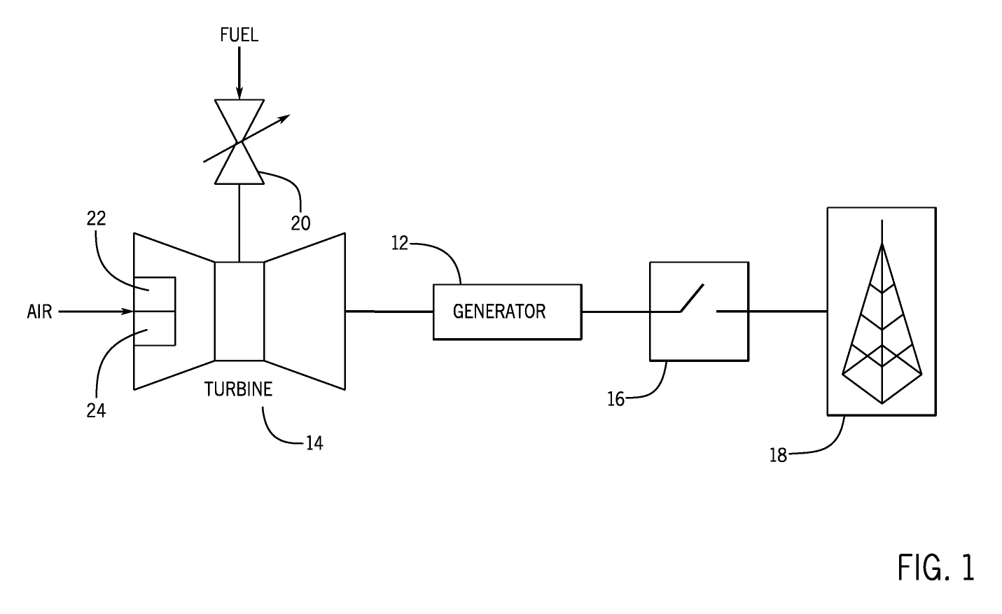

A turbine-generator system may include an exciter circuit that maintains synchronization of the generator (e.g., a rotating shaft of the generator) with an electrical grid when the generator is not outputting real power. As such, the generator may begin to provide power to the electrical grid from a non-fuel burning state (e.g., a state in which the generator is not outputting real power) quickly and almost instantaneously, enhancing stability of the electrical grid. Moreover, when the generator maintains synchronization with the electrical grid in the non-fuel burning state, the generator may generate reactive power that may be delivered to the electrical grid for use. Generally, due to the presence of various reactive power components (e.g., renewable energy sources and/or inductor-driven electric devices, such as washing machines and air conditioners) on the electrical grid, a power factor of the electrical grid may be below a certain threshold during various periods of time. For instance, during off-peak hours, the electrical grid may receive less real power via the generator, as compared to during peak hours. As such, during off-peak hours, the generator may be disconnected from the electrical grid, thereby reducing the power factor of the electrical grid due to the presence of the various sources of reactive power on the electrical grid. To improve the power factor of the electrical grid while the generator is no longer providing real power to the electrical grid, in one embodiment, the generator may remain electrically coupled to the electrical grid while providing reactive power to the electrical grid. In some instances, operating one or more induction motors (e.g., in consumer devices, industrial operations, and the like) may cause a power factor to fall below a certain threshold and cause heavy transmission loss, downgrading the quality of electricity provided by the electrical grid. Typically, the factors that affect the electrical grid's reactive power consumption may be unpredictable, similar to the case of demand for real power from electricity consumers. In general, there is an increasing demand for reactive power due to electricity consumption by power electronics, computers, and large data centers and increases in renewable power generation. Additional details with regard to providing reactive power to the electrical grid via the generator will be discussed below. Keeping this in mind, additional details regarding maintaining synchronization of a generator with an electrical grid and providing reactive power to the electrical grid via the generator are provided below with reference to FIGS. 1-4.

By way of introduction, FIG. 1 is a block diagram of a turbine-generator system 10 that may be employed to maintain synchronization of a generator 12 when the generator 12 is in the non-fuel-burning state, in accordance with an embodiment of the present disclosure. The turbine-generator system 10 may include a turbine 14, the generator 12, a switch 16, and an electrical grid 18. The turbine 14 may include any one or more turbines and may be a simple cycle or a combined cycle turbine. By way of example, the turbine 14 may include a gas turbine, a wind turbine, a steam turbine, a water turbine, or any combination thereof. As illustrated, the turbine 14 may perform mechanical work when the turbine 14 receives sufficient fuel via a fuel input(s) or nozzle(s) 20 and sufficient air via an inlet guide vane(s) (IGV(s)) 22 and/or a variable stator vane(s) (VSV(s)) 24. The IGV 22(s) may be located in front of a compressor of the turbine 14, and direct air onto the compressor at an effective angle or regulate the amount of air flow into the compressor. For an axial compressor, the VSV(s) 24 may be located in a front section of the compressor to direct previously compressed air to a more effective angle or regulate an amount of air flow into the compressor.

The mechanical work output by the turbine 14 may rotate a shaft of the generator 12. The generator 12 may then convert rotating torque of the shaft into electrical energy or real power (e.g., in watts) that may be output to the electrical grid 18 via the switch 16 when the generator 12 is synchronized with the electrical grid 18. Those skilled in the art will recognize that, besides the switch 16, other components and/or circuitry may be included between the generator 12 and the electrical grid 18, such as an additional switch(es), a transformer(s), a load commutated inverter(s), frequency converter(s), and the like, or any combination thereof. As used herein, “real power” may include, in alternating current (AC) circuits, a portion of power generated by the generator 12 that, averaged over a cycle of an AC waveform, results in a net transfer of energy in one direction (e.g., to the electrical grid 18). “Reactive power,” as will be discussed below, may refer to a portion of the power generated by the generator 12 that returns to a source in each cycle of the AC waveform due to stored energy by energy storage elements in the AC circuits, such as inductors and capacitors.

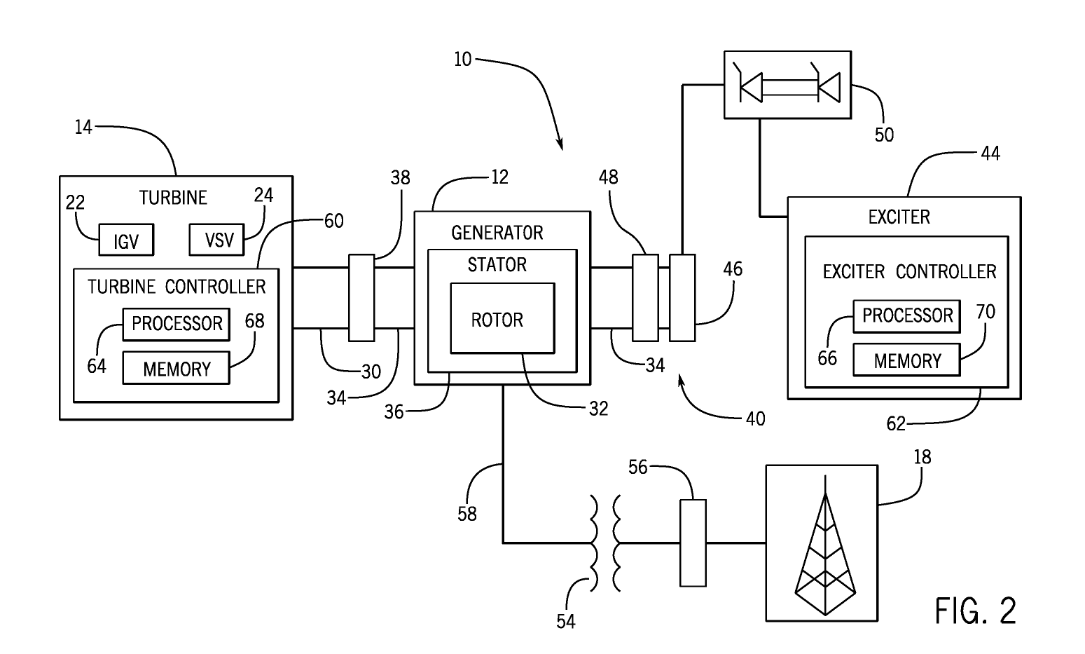

FIG. 2 is a block diagram that illustrates various components of the turbine-generator system 10 of FIG. 1, in accordance with an embodiment of the present disclosure. As illustrated, the generator 12 is coupled to the turbine 14 (e.g., at a shaft 30 of the turbine 14) at a turbine coupling end 38 of the rotor shaft 34. The generator 12 has a rotor 32 and a rotor shaft 34 mounted within a stator 36. The rotor 32 may be wrapped in field windings, while stator 36 may be wrapped in armature windings distributed along a circumference of the stator 36. The field windings of the rotor 32 produce a magnetic field that interacts with the armature windings of the stator 36, which may be powered by a system of three-phase AC voltages. In one embodiment, the generator 12 may be a two-pole, 3600/3000 (60/50 Hz) RPM unit that may spin freely on bearings of the generator 12 when disconnected from the turbine 14.

Those skilled in the art will recognize that not all auxiliary systems associated with the generator 12 are illustrated in FIG. 2. For example, those skilled in the art will appreciate that the generator 12 may have auxiliary systems that include a water supply or other coolants provided to a generator cooler(s) (heat exchanger(s)), a stator winding cooling system, a hydrogen supply and control system for generators using hydrogen as the primary coolant, and bearing lubrication systems, and the like, or a combination thereof.

As illustrated, a set of collector rings 40 proximate to end 42 of the rotor shaft 34 are configured to receive excitation current (e.g., direct current (DC)) generated from an exciter 44. The collector rings 40 include a positive terminal collector ring 46 and a negative terminal collector ring 48. In one embodiment, excitation current is injected in the positive terminal collector ring 46 and the negative terminal collector ring 48 by a silicon-controlled rectifier (SCR) bridge 50. However, embodiments of the present disclosure are not limited to using the SCR bridge 50. Those skilled in the art will recognize that other types of power electronic bridges may be used to inject the excitation current into the collector rings 40. As illustrated, the SCR bridge 50 is part of the exciter 44 that receives an excitation supply and power (e.g., from an auxiliary power bus connected to the electrical grid 18). For example, the auxiliary power bus may provide three-phase current at 50 hertz (Hz) or 60 Hz. The exciter 44 may be any suitable exciter that can provide an excitation supply used for generating DC power. In one embodiment, the exciter 44 may be an EX2100 excitation system provided by General Electric. In some embodiments, those skilled in the art will recognize that the exciter 44 may be modified to provide an alternate source of excitation in instances where the generator 12 uses, for example, an alternator as an exciter.

The exciter 44 may include an electrical circuit that provides DC current and DC voltage to the field windings of the rotor 32, thereby inducing a magnetic field within the generator 12. The magnetic field may cause the rotor 32 to spin inside the generator 12 and rotate the shaft 34 of the generator 12. In addition to creating the magnetic field within the generator 12, the exciter 44 may control amplitude and/or phase properties of the voltage output by the generator 12. As such, the exciter 44 may synchronize the voltage output by the generator 12 with the voltage of the electrical grid 18 after the generator's shaft rotates at its rated speed, such that the rotor 32 of the generator 12 rotates at a speed that is synchronous with the electrical grid 18.

The generator 12 is coupled to the grid 18 and may perform synchronous condenser operations (e.g., generating reactive power, absorbing reactive power and correcting power factor) via a generator step-up transformer 54 and a generator breaker or any other suitable switch 56. The generator step-up transformer 54 raises a voltage provided by the generator 12 from a generator bus 58 to a level that is compatible with the electrical grid 18. Those skilled in the art will recognize that, in some embodiments, the generator step-up transformer 54 may not be included in the turbine-generator system 10. Instead, the generator bus 58 may be directly connected to other generator buses. In some embodiments, an isolation circuit breaker is located between the generator 12 and any other generators on the generator bus 58. As illustrated, the generator circuit breaker 56 may connect and disconnect the generator 12 with the electrical grid 18. In certain circumstances, the generator circuit breaker 56 may isolate the generator 12 from the electrical grid 18 as the rotor 32 accelerates towards an operational speed and connects the generator 12 to the electrical grid 18 upon the rotor 32 reaching the synchronized speed.

As illustrated, the turbine 14 includes a turbine control system or a turbine controller 60 which may control the turbine 14, and the exciter 44 includes an exciter controller 62 which may control the exciter 44. The turbine controller 60 may control fuel flow (e.g., via the fuel nozzle(s) 20) based at least in part on frequency feedback by the electrical grid 18. For example, the turbine controller 60 may maintain a current fuel flow when the frequency of the electrical grid 18 is in a threshold range, such as a grid nominal frequency of 50 Hz (+/−2 Hz) (as in Europe, China, India, Africa, some parts of Japan, and some other Asian countries) or 60 Hz (as in North and South America, some parts of Japan, and some other Asian countries). The threshold ranges may be stricter or laxer depending on the individual country and perceived as a qualitative measure of electricity supply. When the frequency of the electrical grid 18 exceeds the threshold range, the turbine controller 60 may decrease the fuel flow to the turbine 14 via the fuel nozzle(s) 20 to reduce real power output of the generator 12. When the frequency of the electrical grid 18 falls below the threshold range, the turbine controller 60 may increase the fuel flow to the turbine 14 via the fuel nozzle(s) 20 to increase real power output of the generator 12. The exciter controller 62 may control excitation current based at least in part on feedback of the voltage of the electrical grid 18. In particular, when the voltage of the electrical grid 18 decreases, the exciter controller 62 may increase the excitation current.

The turbine controller 60 and the exciter controller 62 may each include a communication component, one or more processors (e.g., 64, 66), one or more memory or storage devices (68, 70), input/output (I/O) ports, and the like. The communication components may include wireless or wired communication components that facilitate communication between each component in the turbine-generator system 10, various sensors disposed about the turbine-generator system 10, and the like. The processors 64, 66 may include any type of computer processor or microprocessor capable of executing computer-executable code. The memory or storage devices 68, 70 may include any suitable articles of manufacture that serve as media to store processor-executable code, data, or the like. These articles of manufacture may represent non-transitory computer-readable media (i.e., any suitable form of memory or storage) that may store the processor-executable code used by the processors 64, 66 to, among other things, perform operations that may be used to control the turbine 14 and/or the exciter 44. The turbine controller 60 and the exciter controller 62 may communicate with each other via a communication network. The communication network may include an Ethernet-based network, such as the Unit Data Highway (UDH) provided by General Electric.

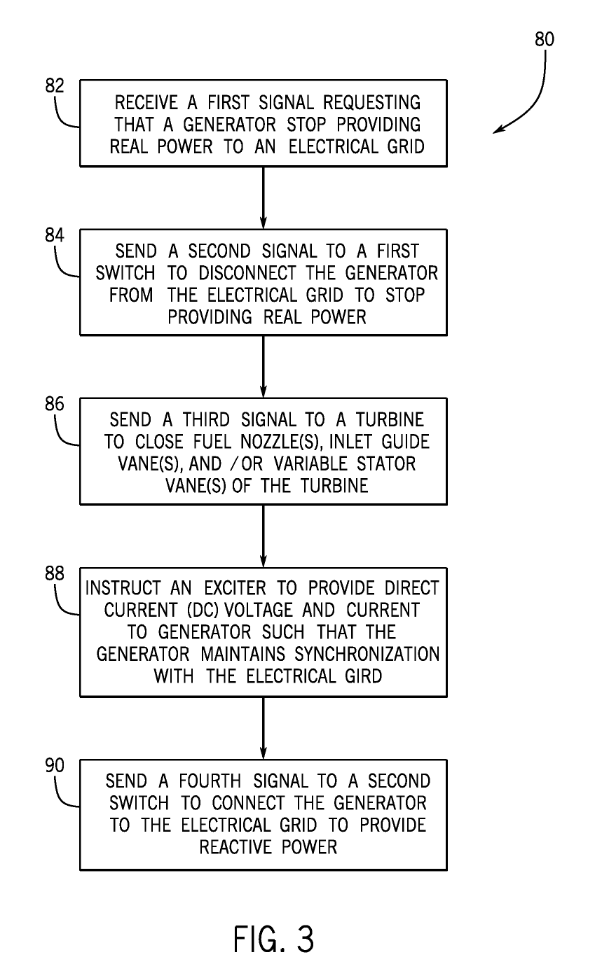

FIG. 3 is a flow diagram of a method 80 for using the generator 12 of FIGS. 1 and 2 to provide reactive power under certain circumstances, in accordance with an embodiment of the present disclosure. Generally, due to the presence of various reactive power components (e.g., renewable energy sources) on the grid 18, the power factor of the grid 18 may be below a certain threshold during various periods of time. For instance, during off-peak hours, the grid 18 may receive less real power via one or more generators 12, as compared to during peak hours. As such, during off-peak hours, the generator 12 may be disconnected from the grid 18, thereby reducing the power factor of the grid 18 due to the presence of various sources of reactive power on the grid 18. In some instances, operating one or more induction motors (e.g., in consumer devices, industrial operations, and the like) may cause a power factor to fall below a certain threshold and cause heavy transmission loss, downgrading the quality of electricity provided by the electrical grid. Typically, the factors that affect the electrical grid's reactive power consumption may be unpredictable, similar to the case of demand for real power from electricity consumers. To improve the power factor of the grid 18 while the generator 12 is no longer providing real power to the grid 18, in one embodiment, the generator 12 may remain electrically coupled to the grid 18 while providing reactive power to the grid 18. Additional details with regard to providing reactive power to the grid 18 via the generator 12 will be discussed below with reference to the method 80.

As disclosed herein, the method 80 is performed by the exciter controller 62 of FIG. 2. However, in alternative embodiments, the method 80 may be performed by a combination of controllers, including the exciter controller 62, or one or more controllers that perform, among other things, the functions of the exciter controller 62, as described above. Additionally, while the steps of the method 80 are presented in a specific order, it should be understood that the steps may be performed in a different order than described below and illustrated in FIG. 3.

The exciter controller 62 may receive (block 82) a first signal requesting that the generator 12 stop providing real power to the grid 18. In some embodiments, an operator or software (e.g., grid management software) may send the first signal to stop the generator 12 from providing real power. This may occur because of decreased demand for power, for example, during off-peak hours. The exciter controller 62 may then send (block 84) a second signal to a first switch (e.g., the switch 16) to disconnect the generator 12 from the electrical grid 18 to stop providing real power to the electrical grid 18. The exciter controller 62 may send the second signal in response to receiving the first signal to stop the generator 12 from providing real power.

The exciter controller 62 may then send (block 86) a third signal to the turbine 14 to close the fuel nozzle(s) 20, the IGV(s) 22, and/or the VSV(s) 24 of the turbine 14. As such, compressor air flow and fuel flow may be prevented from entering the turbine 14. The turbine 14 may therefore no longer provide rotational mechanical power to the generator 12 via the shaft 30.

After closing the fuel nozzle(s) 20, the IGV(s) 22, and/or the VSV(s) 24, the exciter controller 62 may instruct (block 88) the exciter 44 to provide the excitation current to the generator 12 such that the generator 12 maintains synchronization with the electrical grid 18. In particular, the exciter 44 may provide DC current and DC voltage to the field windings of the rotor 32, thereby inducing a magnetic field within the generator 12. The exciter 44 may be connected to the electrical grid 18, from which the exciter 44 draws power (e.g., real power) to provide the DC current and the DC voltage. The magnetic field may cause the rotor 32 to spin inside the generator 12 and rotate the shaft 34 of the generator 12. The exciter 44 may also control amplitude and/or phase of the voltage output by the generator 12 to synchronize the voltage output by the generator 12 with the voltage of the electrical grid 18 after the generator's shaft rotates at its rated speed. As such, the DC voltage and the DC current provided by the exciter 44 may cause the generator 12 to operate synchronously with the electrical grid 18.

Because the turbine 14 is coupled to the turbine coupling end 38 of the rotor shaft 34, the turbine 14 may also maintain a nonzero speed despite not providing rotational mechanical power to the generator 12. In some embodiments, the turbine speed may be a synchronized RPM (e.g., the speed of the generator 12 when synchronized with the electrical grid 18), depending on a frequency of the electrical grid 18 (e.g., 3000 RPM for 50 Hz grid, 3600 RPM for 60 Hz grid, and the like). The turbine 14 may also maintain a pressure in a vacuum of a cavity of the turbine 14 that is less than, for example, 5 pounds per square inch absolute (PSIA) (e.g., 4 PSIA, 2 PSIA, 1 PSIA) to reduce energy used to maintain rotation of the turbine shaft.

At this point, the real power consumed by the generator 12 may be less than 1% (e.g., 0.1%, 0.2%, 0.5%, 0.7%, and the like) of a rated power output of the generator 12, and may range from 0.8% to 1.5% (e.g., 0.8%, 0.9%, 1.0%, 1.25%, 1.5%, and the like) of a nominal power of the generator 12. In some embodiments, excitation current may be 35% to 65% (e.g., 40%, 50%, 60% and the like) more than a nominal value for over-excitation of the field windings of the rotor 32 to increase or maximize reactive power generation.

The exciter controller 62 may then send (block 90) a fourth signal to a second switch (e.g., switch 56) to connect the generator 12 to the electrical grid 18 to provide reactive power. For example, the reactive power provided by the generator 12 may range from 0% to 100% (e.g., 0%, 5%, 10%, 25%, 50%, 75%, 85%, 90%, 100%, and the like) of rated mega volt amps (MVAs) of the generator 12. This may occur, for example, when the generator 12 is synchronized with the electrical grid 18. As such, the turbine-generator system 10 may perform a synchronous condenser operation to generate or absorb reactive power

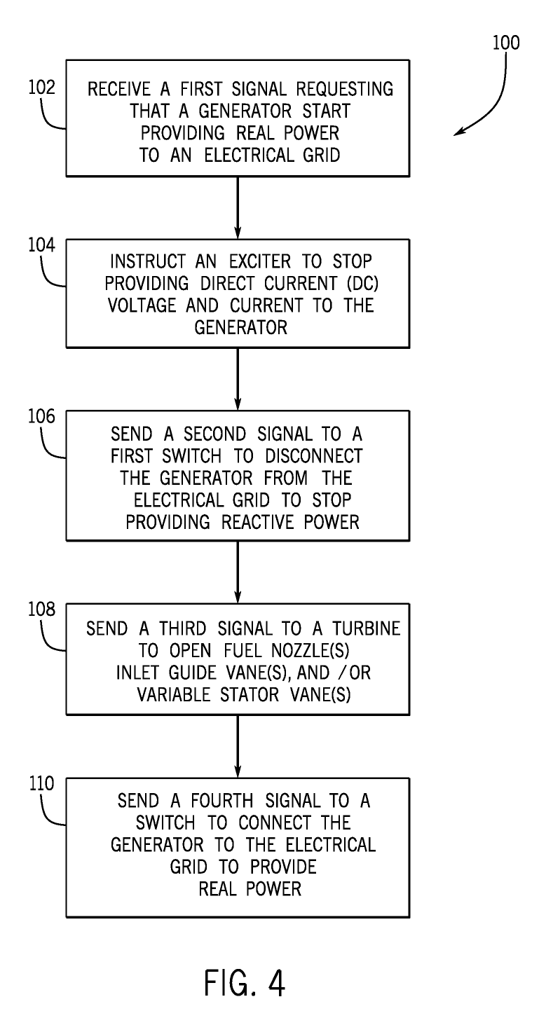

While the generator 12 is providing reactive power to the grid 18, the generator 12 may be requested to provide real power to the grid 18 in relatively short order (e.g., seconds). As such, FIG. 4 is a flow diagram of a method 100 for using the generator 12 of FIGS. 1 and 2 to provide real power, in accordance with an embodiment of the present disclosure. As disclosed herein, the method 100 is performed by the exciter controller 62 of FIG. 2. However, in alternative embodiments, the method 80 may be performed by a combination of controllers, including the exciter controller 62, or one or more controllers that perform, among other things, the functions of the exciter controller 62, as described above. Additionally, while the steps of the method 100 are presented in a specific order, it should be understood that the steps may be performed in a different order than described below and illustrated in FIG. 4.

The exciter controller 62 may receive (block 102) a first signal requesting that the generator 12 start providing real power to the grid 18. In some embodiments, an operator or software (e.g., grid management software) may send the first signal to start providing real power from the generator 12. This may occur because of increased demand for power, for example, during peak hours. The exciter controller 62 may instruct (block 104) the exciter 44 to stop providing reactive power to the generator 12. In particular, the exciter controller 62 may instruct the exciter 44 to stop providing DC current and DC voltage to the field windings of the rotor 32, thereby reducing the magnetic field within the generator 12 and causing the rotor 32 to slow without intervention. The exciter 44 may also stop drawing power (e.g., real power) from the electrical grid 18.

The exciter controller 62 may then send (block 106) a second signal to a first switch (e.g., the SCR bridge 50) to disconnect the generator 12 from the electrical grid 18 to stop providing reactive power. The exciter controller 62 may send (block 108) a third signal to the turbine 14 to open the fuel nozzle(s) 20, the IGV(s) 22, and/or the VSV(s) 24 of the turbine 14. As such, compressor air flow and fuel flow may start entering or increase in the turbine 14. Because the rotor 32 is already running at a synchronized speed, the IGV(s) 22 and/or VSV(s) 24 may be set to certain positions and/or the fuel nozzle(s) 20 may be controlled to ensure a certain fuel/air ratio to start the turbine 14. For example, the IGV(s) 22 may be set to a position from 5% open to 50% open (e.g., 10% open, 20% open, 30% open, 40% open, and the like). The turbine 14 therefore starts to provide rotational mechanical power to the generator 12 via the shaft 30.

The exciter controller 62 may send (block 110) a fourth signal to a switch (e.g., the switch 16) to connect the generator 12 to the electrical grid 18 to provide real power. This may occur, for example, when the generator 12 is outputting power synchronously with the electrical grid 18. As such, the turbine-generator system 10 may generate and provide real power to the electrical grid 18.

Technical effects of the present disclosure include the turbine-generator system 10 that includes the exciter 44 that maintains synchronization of the generator 12 (e.g., a rotating shaft 34 of the generator 12) with the electrical grid 18 when the generator 12 is not in use (i.e., offline). As such, the generator 12 may begin to provide power to the electrical grid 18 from the non-fuel burning state quickly and almost instantaneously, enhancing stability of the electrical grid 18. Moreover, while the generator 12 maintains synchronization with the electrical grid 18 in the non-fuel burning state, the generator 12 may generate reactive power that may be delivered to the electrical grid 18 for use.

This written description uses examples to disclose the present disclosure, including the best mode, and also to enable any person skilled in the art to practice the present disclosure, including making and using any devices or systems and performing any incorporated methods. The patentable scope of the present disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a turbine comprising a turbine control system and at least one fuel nozzle, at least one inlet guide vane, or at least one variable stator vane;
a generator configured to couple to the turbine, wherein the generator is configured to provide power to an electrical grid;
an exciter configured to provide a direct current (DC) voltage and a DC current to a rotor of the generator, wherein the exciter comprises a controller configured to:
receive a first signal requesting that the generator stop providing real power to the electrical grid;
send a second signal to the turbine control system to close the at least one fuel nozzle, the at least one inlet guide vane, or the at least one variable stator vane in response to receiving the first signal; and
instruct the exciter to provide the DC voltage and the DC current to the rotor of the generator, wherein the DC voltage and the DC current are configured to cause the generator to operate synchronously with the electrical grid.

2. The system of claim 1, comprising a switch configured to couple the generator to the electrical grid, wherein the controller is configured to send a third signal to the switch to disconnect the generator from the electrical grid in response to receiving the first signal requesting that the generator stop providing real power to the electrical grid.

3. The system of claim 2, comprising a switch configured to couple the generator to the electrical grid to provide reactive power, wherein the controller is configured to send a third signal to the switch to connect the generator to the electrical grid when the generator operates synchronously with the electrical grid.

4. The system of claim 3, comprising a silicon-controlled rectifier configured to output the DC voltage and the DC current.

5. The system of claim 1, wherein a shaft of the turbine rotates with the generator when the exciter provides the DC voltage and the DC current to the rotor of the generator.

6. The system of claim 1, wherein a speed in which a shaft of the turbine rotates is 3000 RPM when a frequency of the electrical grid is 50 Hz.

7. The system of claim 1, wherein a speed in which a shaft of the turbine rotates is 3600 RPM when a frequency of the electrical grid is 60 Hz.

8. A method, comprising:
receiving, via one or more processors, a first signal requesting that a generator stop providing real power to an electrical grid;
sending, via the one or more processors, a second signal to a turbine control system to close at least one fuel nozzle, at least one inlet guide vane, or at least one variable stator vane in response to receiving the first signal; and
instructing, via the one or more processors, an exciter coupled to a rotor of the generator to provide direct current (DC) voltage and the DC current to the rotor of the generator, wherein the DC voltage and the DC current are configured to cause the generator to operate synchronously with the electrical grid.

9. The method of claim 8, comprising sending, via the one or more processors, a third signal to a switch to disconnect the generator from the electrical grid to stop providing real power in response to receiving the first signal requesting that the generator stop providing real power to the electrical grid, wherein the switch is configured to couple the generator to the electrical grid.

10. The method of claim 8, comprising sending, via the one or more processors, a third signal to a switch to connect the generator from the electrical grid to start providing reactive power when the generator operates synchronously with the electrical grid, wherein the switch is configured to couple the generator to the electrical grid.

11. The method of claim 8, comprising receiving, via the one or more processors, a third signal requesting that the generator start providing real power.

12. The method of claim 11, comprising instructing, via the one or more processors, the exciter to stop providing DC voltage and the DC current to the rotor of the generator in response to receiving the third signal requesting that the generator start providing real power.

13. The method of claim 12, comprising sending, via the one or more processors, a fourth signal to the turbine control system to open the at least one fuel nozzle, the at least one inlet guide vane, or the at least one variable stator vane in response to receiving the third signal requesting that the generator start providing real power.

14. The method of claim 13, comprising sending, via the one or more processors, a fifth signal to a switch to disconnect the generator from the electrical grid to stop providing reactive power in response to receiving the third signal requesting that the generator start providing real power, wherein the switch is configured to couple the generator to the electrical grid.

15. The method of claim 13, comprising sending, via the one or more processors, a fifth signal to a switch to connect the generator to the electrical grid to start providing real power in response to receiving the third signal requesting that the generator start providing real power, wherein the switch is configured to couple the generator to the electrical grid.

16. Exciter circuitry, comprising:
a controller configured to:
receive a first signal requesting that a generator coupled to the exciter circuitry stop providing real power to an electrical grid;
send a second signal to a turbine control system of a turbine coupled to the generator to close at least one fuel nozzle, at least one inlet guide vane, or at least one variable stator vane in response to receiving the first signal; and
instruct the exciter circuitry to provide direct current (DC) voltage and DC current to a rotor of the generator, wherein the DC voltage and the DC current are configured to cause the generator to operate synchronously with the electrical grid.

17. The exciter circuitry of claim 16, wherein the DC voltage and the DC current are configured to cause the rotor of the generator to rotate at a speed that is synchronous with the electrical grid.

18. The exciter circuitry of claim 16, wherein the controller is configured to receive a third signal requesting that the generator start providing real power.

19. The exciter circuitry of claim 18, wherein the controller is configured to instruct the exciter circuitry to stop providing DC voltage and the DC current to the rotor of the generator in response to receiving the third signal requesting that the generator start providing real power.

20. The exciter circuitry of claim 18, wherein the controller is configured to send a fourth signal to the turbine control system to open the at least one fuel nozzle, the at least one inlet guide vane, or the at least one variable stator vane in response to receiving the third signal requesting that the generator start providing real power.
